(19) United States
(12) Patent Application Publication
(10) Pub. No.: US 2025/0036365 A1
(43) Pub. Date: Jan. 30, 2025

(54) Method for System Description and Computer System on an Atomic Base Structure of Self-Similar Components

(71) Applicant: Siemens Aktiengesellschaft, München (DE)

(72) Inventors: Stefan Horn, Erlangen (DE); Rupert Maier, Eggolsheim (DE); Regina Hornung, Nürnberg (DE); Manfred Sand, Fürth (DE)

(73) Assignee: Siemens Aktiengesellschaft, München (DE)

(21) Appl. No.: 18/716,382

(22) PCT Filed: Dec. 7, 2022
(86) PCT No.: PCT/EP2022/084823

§ 371 Date: Jun. 5, 2024

(30) Foreign Application Priority Data
Dec. 9, 2021 (EP) 21213443.1

(51) Int. Cl. G06F 8/20

(52) U.S. Cl. CPC G06F 8/20

(57) ABSTRACT

Various embodiments of the teachings herein include methods for system description. An example method includes: forming a standardized structure for describing components, including a predefined set of features, aggregation rules, and interdependencies; editing the description, dividing individual components and subcomponents into the structure, and describing them, wherein the descriptions then form the hierarchical system description by definition and combination; receiving information from other software modules for sorting, wherein a semantic description is given of how, when, and which data is to be taken from which software module or data repository; analyzing the components using a recursive algorithm and deriving the characteristic values required; generating analysis results for the knowledge level of the system to be described; and transmitting output of system description data in preset formats in accordance with specified rules.

### CROSS-REFERENCE TO RELATED APPLICATIONS

This application is a U.S. National Stage Application of International Application No. PCT/EP2022/084823 filed Dec. 7, 2022, which designates the United States of America, and claims priority to EP application Ser. No. 21/213,443.1 filed Dec. 9, 2021, the contents of which are hereby incorporated by reference in their entirety.

### TECHNICAL FIELD

The present disclosure relates to computer systems. Various embodiments of the teachings herein include systems and/or methods for creating a system description based on an atomic base structure of self-similar components.

### BACKGROUND

A great challenge in the development of software products at the moment is to describe a software product that is to be newly implemented, along with its requirements, in such a way that the developed system can be assessed prospectively as well as retrospectively with regard to the fulfillment of technical requirements and design. With complex software systems in particular, a complete description of the requirements for a system that is to be newly implemented is just as complex and expensive as the development itself.

Management is always required, not just in advance of software development but also during the development and maintenance of complex software systems, in order to bring together and coordinate individual project steps and development steps. This development management frequently makes software development inefficient, non-transparent and error-prone. Current approaches in software development employ central, but sequential, development management using conventional management models. One such approach, in which an attempt is made in advance to think through and define all requirements and scopes, always has to take into account corresponding change processes, making it a complex, expensive and inflexible procedure.

In agile software development management, objectives and requirements have hitherto not been specifically defined and a decentralized approach has been followed, in which the focus is on individual component development. More complex systems cannot be optimally integrated in this way. Nor is a separation of problem space and solution space in the field of software development suitable for complex software systems. In all cases later corrections or subsequent design changes result in inconsistency and reductions in quality.

### SUMMARY

Consequently, an improved solution would avoid the disadvantages known from the prior art. In particular, the solution should be sustainable and should uncover interdisciplinary inconsistencies at an early stage. For example, some embodiments of the teachings herein include a computer-implemented method (20) for system description, comprising: formation of a standardized atomic base structure (CS) for the description of individual components of a system, so that all components (C) are self-similar, wherein the description is made from a predefined set (pre) of features (val), aggregation rules and interdependencies; editing of the system description (SD), wherein the system is firstly divided up hierarchically into individual components and subcomponents as far as an atomic base structure, and the individual components (C) and subcomponents (sub) are described, wherein the descriptions of the individual components and subcomponents then form the hierarchical system description (SD) by definition and combination; receipt (I) of project-relevant information (PI) automatically from other software modules and for sorting into the appropriate locations in the system description (SD), wherein for the automated processing a semantic description is given of how, when and which data (PI) is automatically to be taken over from which software module or data repository; analysis of the components (C) by a recursive algorithm (AM) and derivation of the characteristic values (val) required for the system description (SD), wherein the definition of aggregation rules for individual components (c) and subcomponents (sub) thereof takes place such that the aggregation rules describe how the features (val) can be aggregated across subcomponents (sub), so that an automated calculation is performed across all components (C) and subcomponents (sub) of the system description (SD) and analysis results are generated for the knowledge level of the system to be described; and automated output (O) of system description data (data) in preset formats in accordance with specified rules.

In some embodiments, the method (20) further comprises a standardized definition of interdependencies (Q) to other subcomponents (sub).

In some embodiments, each of the individual component descriptions is self-contained and can be considered independently.

In some embodiments, dependencies to other components (C) are defined at the respectively higher-level component level and are mirrored into the lower-level components (sub).

In some embodiments, the recursive algorithm (AM) takes into account the recursion rule that all paths are run through.

In some embodiments, the recursive algorithm (AM) takes into account the recursion rule that the aggregation of the numerical values or other aggregatable individual features (val) takes place in the components (C) run through.

In some embodiments, the recursive algorithm (AM) takes into account the recursion rule that dependencies are defined by the formation of references between tasks inside a component (C).

In some embodiments, the recursive algorithm (AM) takes into account the recursion rule that individual features (val) are only actively taken into account in connection with specified data constellations or for a specified calculation.

In some embodiments, a specified calculation to be taken into account is a specified task which arises only under specified conditions.

As another example, some embodiments include a computer system (10) for executing one or more of the methods described herein, having: memory module for storage of the system description (SD); software module (SE) for editing the system description (SD), wherein the system is firstly divided up hierarchically into individual components and subcomponents as far as an atomic base structure (CS), and the individual components and subcomponents are described, wherein the descriptions of the individual components and subcomponents then form the hierarchical system description (SD) by definition and combination; software module (OE) for organization editing with a functionality for importing, copying and organizing system description components; receipt module (I) for receiving project-relevant information (PI) automatically from other software modules and for sorting into the appropriate locations in the system description (SD), wherein for the automated processing a semantic description is given of how, when and which data is automatically to be taken over from which software module or data repository; analysis module (AM), which automatically performs calculations across all components and subcomponents of the system description and generates analysis results for the knowledge level of the system to be described; and output module (O) for the automated output of system description data (data) in preset formats in accordance with specified rules.

In some embodiments, the computer system (10) further comprises a software module (ME) for editing and defining cross-system features (val).

In some embodiments, the computer system (10) further comprises a software module (QE) for editing a description of interdependencies between individual subcomponents, in particular on the basis of a predefined (pre) semantic vocabulary.

In some embodiments, the computer system (10) further comprises an output module (O), which is configured to forward the system description data (data) to other systems in accordance with specified rules.

The configurations and developments described can be combined with one another as desired, where this makes sense. Further possible configurations, developments and implementations of the teachings herein comprise non-explicitly mentioned combinations of features of the invention described previously or below in respect of the exemplary embodiments.

### BRIEF DESCRIPTION OF THE DRAWINGS

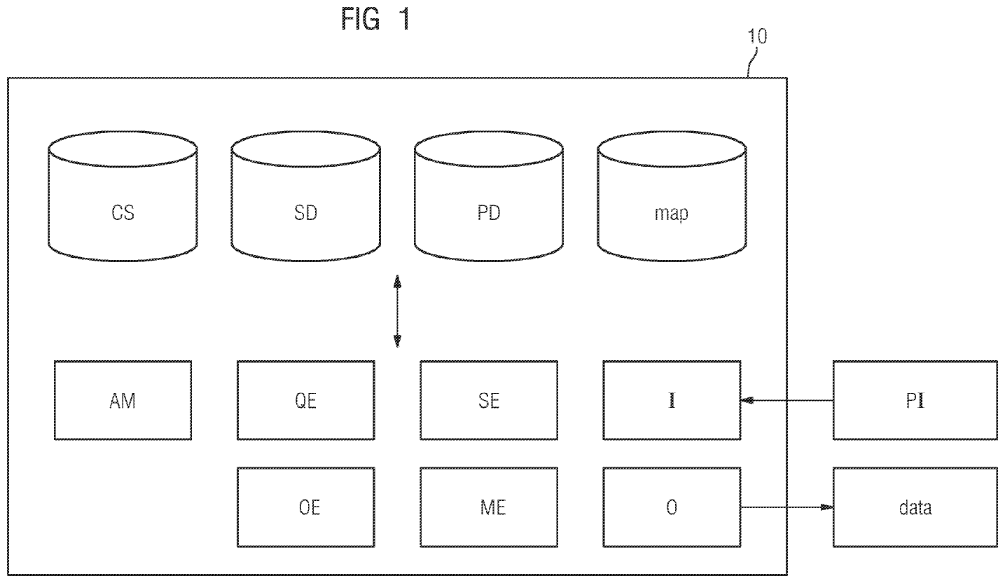

The accompanying FIGS. 1 to 3 of the drawing provide a further understanding of the teachings of the present disclosure. They illustrate example embodiments and in connection with the description serve to clarify principles and concepts of the disclosure. Other forms of embodiment and many of the advantages mentioned arise in respect of the drawings. The elements of the drawings are not necessarily shown true to scale. The same reference characters in this case refer to the same or similarly acting components.

### DETAILED DESCRIPTION

The methods for system description described herein-starting for example from customer benefit-comprises the formation of a standardized atomic base structure for the description of individual components in a system, so that all components are self-similar, wherein the description is made from a predefined set of features, aggregation rules and interdependencies, following which the system description is edited, the system firstly being divided up hierarchically into individual components and subcomponents as far as an atomic base structure, and the individual components and subcomponents being described, the descriptions of the individual components and subcomponents then forming the hierarchical system description by definition and combination. The method further comprises the receipt of project-relevant information, which takes place automatically from other software modules, and the sorting of the project-relevant information into the appropriate locations in the system description, a semantic description being given for the automated processing of how, when and which data is to be taken over automatically from which software module or data repository. The method additionally comprises the analysis of the components by a recursive algorithm and the derivation of the characteristic values necessary for the system description, the definition of aggregation rules for individual components and subcomponents thereof being performed such that the aggregation rules describe how the features can be aggregated across subcomponents, such that an automated calculation is performed across all components and subcomponents of the system description and analysis results are generated for the knowledge level of the system to be described. Lastly, the method also comprises the automated output of system description data in preset formats in accordance with a specified rule.

The decomposition of a complex system is thus done on the basis of a self-similar decomposition rule. It is thereby ensured that uniform data formats and uniform procedures are in place at all levels of the system, since all individual parts then again use the same decomposition rules. The advantage of this is that it is possible successively to add new system components of virtually any complexity. A system description in the context of the application should be understood as information about the elements present in a system and their connections to one another. For example, a system can comprise different components, modules from hardware as well as software.

The term standardized atomic base structure should be understood as an identical description of individual components, so that dependencies and features are described in a uniform manner. The term self-similar in the context of the application means that a structuring rule of an object is self-similar if it describes the object by the interaction of sub-objects, whose own structuring rule has the same structure as that of the object. Such self-similar structuring rules can be created in infinite complexity and depth using recursive algorithms and can be examined automatically. A recursive algorithm is a calculation rule which relies on partial results arising from the use of the same calculation rule. Examples of aggregation rules include addition, formation of a minimum or maximum, formation of a cross-section or similar.

The methods described herein have advantages, among others, that individual self-similar subcomponents of any complex system can be described. The methods hence enable account to be taken of any features, such as for example customer benefit, costs, processing time, delivery time or personnel requirements. The method in particular covers inconsistencies and thus enables timely and comprehensive control. The method described enables a flexible, generic, cross-functional and interdisciplinary structure to describe components at an early stage in system development. This includes budget definition as well as reporting and controlling over time. This enables budget-friendly and timely countermeasures to be taken if inconsistencies are detected.

In some embodiments, the method comprises a standardized definition of interdependencies to other subcomponents. The system descriptions arising on the basis of the described method are thus based on data from the problem space and solution space and the combination of this data results in a tree-shaped system architecture, which however is able to describe and take account of interdependencies between components.

In some embodiments, each of the individual component descriptions are self-contained and can be considered independently. Definitional rules can be present in each component. With the help of the existing inheritance mechanism these define how the underlying subcomponents must be described and treated, for example as regards which features must be described and treated.

In some embodiments, dependencies to other components are defined at the respective higher-level component level and are mirrored into the lower-level component. A dependency between subcomponents is thus described at the higher system level by assembling contributions of the subcomponents. These contributions are in turn likewise described inside the subcomponents, in other words are mirrored. This ensures that dependencies arise only along the component-to-subcomponent relationship and not across component boundaries.

The interaction of individual components and the overall system behavior relevant for understanding can be determined completely and in any complexity by means of recursive application of an evaluation algorithm which only describes the assembly of one level. The methods described herein are thus able to create system descriptions which can be analyzed automatically, so that the specific data can be derived from the system description which is required for individual selected management tasks. Such data derivations are supplied by the recursive algorithm, which takes into account not only the individual aspects of individual components, but simultaneously also those of the overall system described.

The recursion rule that all paths must be run through is taken into account by the recursive algorithm. In some embodiments, the recursion rule that the aggregation of the numerical values or of other aggregatable individual features takes place in the components that are run through is taken into account by the recursive algorithm. In some embodiments, the recursion rule that dependencies are defined by formation of references between tasks inside a component is taken into account by the recursive algorithm. In particular, the recursion rule that individual features are only actively taken into account in connection with specified data constellations or for specified calculations is taken into account. A specified calculation to be taken into account is in particular a specified task which arises only under specified conditions.

The term feature should be understood as an algorithmically utilizable attribute of an object, such as numbers, character strings, lists or the like, which have a substantive meaning for the description of the entire system. Such features are also referred to as values. A data constellation should be understood in particular as a reference to other features.

The methods described herein may provide sufficient planning security for system development, in that exactly as much is described as is necessary for the development, but necessary degrees of freedom for the detailed configuration can nevertheless be left open. For example, no fixed timeframes exist for when which information for the detailing of individual subcomponents of the system is specified. An evaluation can always take place on the basis of existing data and can be repeated at any time. The management of an individual underlying project can for example be based on a system detailing or project detailing which for this purpose defines on the fly only the respectively required features and interdependencies. By means of such a procedure it is relatively easy to identify anomalies in a system structure and a countermeasure is possible exactly where it is necessary. At the same time a superfluous accumulation of information is avoided.

An computer system for execution of one or more of the methods herein for system description has a memory module for storage of the system description, a software module for editing the system description, the system firstly being divided up hierarchically into individual components and subcomponents as far as an atomic base structure, and the individual components and subcomponents being described, the description of the individual components and subcomponents then forming the hierarchical system description by definition and combination, a software module for organization editing with a functionality for importing, copying and organizing system description components, a receipt module for receiving project-relevant information automatically from other software modules and for sorting into the appropriate locations in the system description, a sematic description being given for the automated processing of how, when and which data is to be taken over automatically from which software module or data repositories. An analysis module, which automatically performs calculations across all components and subcomponents of the system description and generates analysis results for the knowledge level of the system to be described, and lastly an output module for the automated output of system description data in preset formats in accordance with specified rules.

A receipt module is an input component for coupling to other systems which supply project-relevant information to the object described. Such project-relevant information may for example be: information on the development progress of individual subcomponents, for identification of new problem areas, for maintenance or upkeep needs, future upgrades or similar.

The analysis module may comprise a recursive feature computer or the analysis module includes a recursive feature computer which automatically performs calculations across all components and subcomponents of the system description and generates analysis results to the knowledge level of the specified system, the calculation of the analysis results being possible at any time. Thus it can be ensured that for each change to the system description a recalculation takes place automatically on the fly, so that up-to-date analysis data is always present. The analysis module can be a hardware component, for example a processor or part of a processor or in the sense of the recursive feature computer in conjunction with a software module or comprising software which is executed by means of a processor.

The output module is an output component which is able to output system description data and results data automatically from the recursive feature computer to other systems in accordance with specified rules. Such other systems are for example project management tools such as MS Project. The output takes place in particular in preset formats, for example CSV, PDF, XLS, email, etc.

The computer system described, in particular of the organization editor, may be used for the successive ascertainment and completion of the resultant system description, for example by insertion of existing product descriptions, of necessary subcomponents or enables the addition of new knowledge on individual components.

In some embodiments, the computer system has a software module which is used to edit and define cross-system features. This should be understood in particular as a change or deletion. In some embodiments, the computer system has a software module to edit a description of interdependencies between individual subcomponents, in particular on the basis of a predefined semantic vocabulary. For example, the information may be: “Can only be implemented after subcomponent X” or “Can only be implemented together with subcomponent Y” or for instance “Superfluous if subcomponent Z exists”, etc. The advantage of this is that the description is machine-interpretable.

The expression computer system is in particular understood as any type of electronic device with data processing properties. Computers or computer systems may thus for example be personal computers, servers, handhelds, pocket PC devices, mobile radio devices and other communication devices as well as processors and other electronic devices for data processing. In the wider sense a computer system may also be understood as a computer network, a network, a network unit or a cloud computing system.

In some embodiments, the computer system comprises a flexible, generically cross-functional and interdisciplinary structure, which enables a component description at an early stage of system development.

In some embodiments, the computer system has an output module which is equipped to forward the system description data to other systems in accordance with specified rules. Other systems may be project management tools such as for example MS Project. Preset formats may be CSF, PDF, XLS, email, etc.

The methods and the systems for execution of the method thus define a new software system, in which a very timely and cross-functional, i.e. interdisciplinary, system description ideally supports the management of the software development. The system description thus enabled is in particular of a generic nature, uses existing knowledge from the problem space and solution space, without claiming to be complete in advance. The method described is based in particular on a fractal decomposition of the system to be considered and the system description thereof. In particular, it is made possible to design an overall system in compliance with existing standard solutions at subsystem level. This prevents the view of the whole from being lost when disciplines that actually belong together are viewed in isolation.

FIG. 1 schematically shows an example system 10 incorporating teachings of the present disclosure with the hardware and software components thereof, such as for example the atomic base structure or component structure CS, comprising self-similar components C, such as for example quality, customer benefit assignment or feature assignment. The system has at least one I/O component for receipt I of for example project-relevant information PI, data, for example development tool GIT, and for the automated output O, for example of system description data data, in particular in preset formats in accordance with specified rules, for example project management tool MS Project, Polarion, TFS, backlog, VS Cards, TC/SAP, TCPCM. A central component is the recursive feature computer AM, which executes the recursive algorithm. The system 10 further has at least one memory pre of predefined feature definitions, aggregation rules and interdependency types Q and mapping rules map for continuous input and output. Product descriptions PD are advantageously also stored on the system 10. The system additionally comprises software components such as for example the interdependency editor QE, the system description editor SE, the organization editor OE and the feature editor ME.

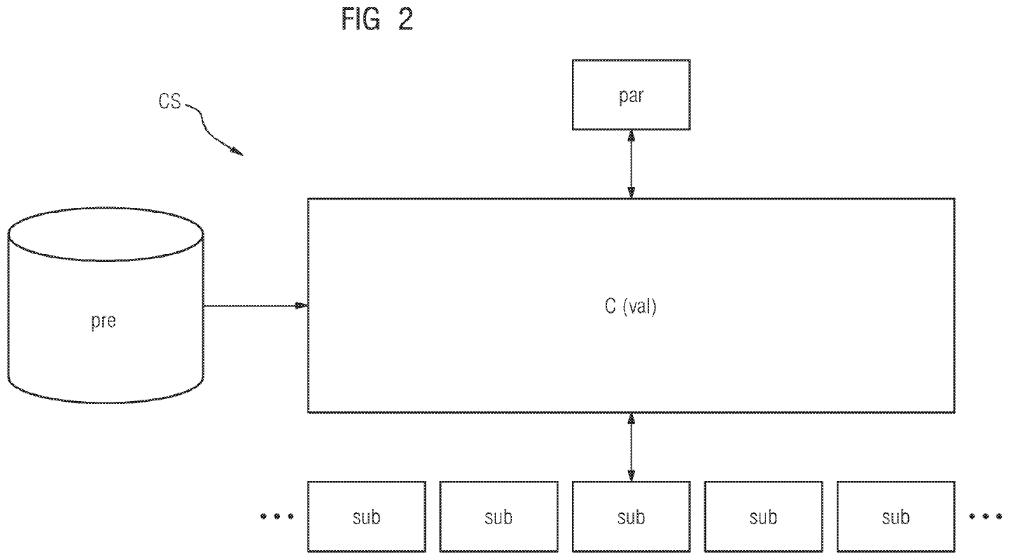

FIG. 2 schematically illustrates the relationships to higher-level parent components and lower-level child components. Features val, such as for example characteristic values, are for example defined via a link to predefined feature definitions pre. Features may for example be: a component-specific value c (val) which may be specified manually or may be determined by aggregation, the aggregation rule to be applied being in particular designed for a component C. A component C in particular also comprises a definition of interdependencies Q between the lower-level children, the subcomponents sub. Subcomponents are for example design, budget, performance, execution, plausibility, consistency, HW and SW balancing, guidelines, dependencies, planning data and prioritization thereof, based on speed, scheduling, participants, skills, risks, etc.

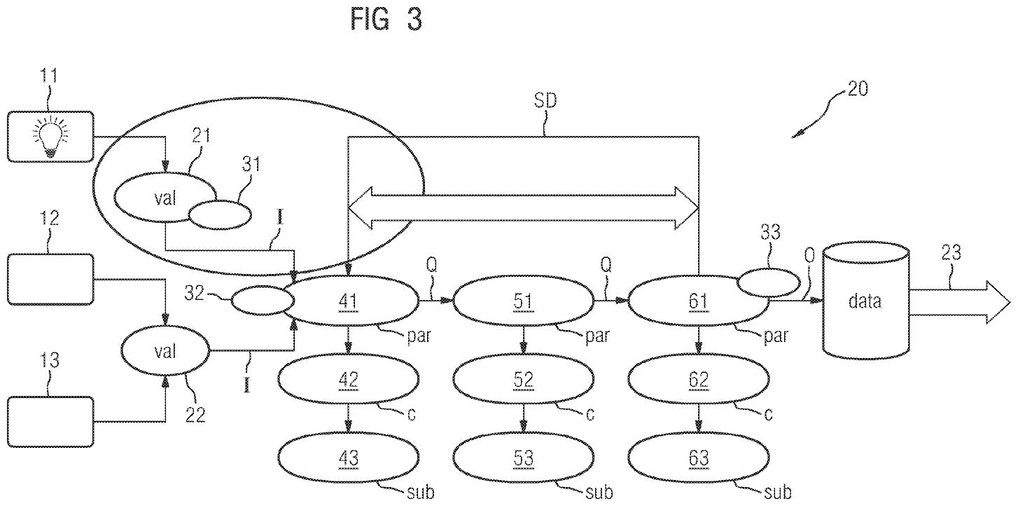

FIG. 3 shows a diagram for illustration of an example method 20 incorporating teachings of the present disclosure from the product idea 11 to the project plan 23: data data, in particular for market analysis, market survey, in particular as regards relevance, priority and fulfillment 12, as well as CVE benchmarks 13, but also overarching features of the idea 21 and customer-specific features 22, known as customer values, are imported I into the system 10. In this case certain criteria 31, 32, 33 are to be satisfied or questions answered, such as for example why a product should be designed and how it should be equipped, this then being formulated in quality features 41. Sub-features c, sub are for example design features 42 and budget estimates or effort estimates or commercial criteria 43. The method continues horizontally in the formulation of value assignments 51, which in turn have lower-level components such as plausibility check 52 and consistency balance 53, in particular HW/SW balancing, a consideration of whether the customer benefit is more favorable to implement in HW or SW. The process continues further with the functional assignment 61: this relates to lower-level values such as guidelines, dependencies and performance 62 as well as prioritization of planning data 63. Planning data can for example be based on effort, speed and schedule, skills and risk, participants and other features. Lastly the data output O comprises data data for TFS, Polarion, Backlog, VS Cards, TC/SAP or TcPCM.

This procedure optimizes the handling of projects in the complex systems environment by automatically determining up-to-date management data par, c, sub. Minimally required effort for the creation of the system description. The tree-shaped structure creates a clear, easily and automatically manageable system description. Nevertheless, non-hierarchical aspects can readily be described and also analyzed via the definition of dependencies and interdependencies. Changes to the system description are automatically displayed in the database and can thereby be carried out at any time at each level of the tree-shaped structure. Thanks to the self-similar detailing, questions arise where they can also be dealt with.

Snapshots for two different specimen system descriptions are shown below in table form:

Customer benefit: A basement space is to be converted into a living
space.

| ├ Initial requirement of the building owner: | | |
|---|---|---|
| \| | └ | An existing basement space is to be converted so that it is |
| | possible to live in it | |
| \| | | ├ Size of space 25 m² |
| \| | | ├ Total wall area 65 m² |
| \| | | ├ External wall area 30 m² |
| \| | | └ Converted space 70 m³ |

| | |
|---|---|
| └ | Products of a project partner: Remodel existing spaces as |

requested

| | |
|---|---|
| └ | Objective: Living space quality as per DIN |
| | ├ Room climate requirement analysis |
| | ├ Product: Living space dryness as per DIN |

| \| | ├ Object: Eliminate risk of mold infestation due to damp | | | | |
|---|---|---|---|---|---|
| \| | \| | ├ Product: Eliminate damp from outside | | | |
| \| | \| | \| | └ | Objective: Building structure should be protected | |
| | | | against penetration of damp | | |
| \| | \| | \| | | ├ | Product: Determine cause of damp |
| \| | \| | \| | | ├ | Product: Eliminate cracks in the external wall |
| \| | \| | \| | | ├ | Product: Seal wall from outside |
| \| | \| | \| | | └ | Product: Lay/renew drainage |
| \| | \| | \| | | | ├ Determine accessibility and infrastructure |
| \| | \| | \| | | | ├ Lay drainage |
| \| | \| | \| | | | ├ Excavate |
| \| | \| | \| | | | └ Connect to sewer |

| \| | \| | └ Product: Damp from below | | |
|---|---|---|---|---|
| \| | \| | | └ | Objective: Building structure should be protected |

against rising damp

| | |
|---|---|
| \| | └ Penetration of damp at the interfaces |

└ Product: Pollution

├ Objective: Eliminate mold spores
└ Objective: Eliminate harmful building materials

Customer benefit: Comprehensive entertainment experience

| | |
|---|---|
| ├ | Value: Integration of high-end entertainment products to form a |

home entertainment system

| \| | └ | Quality: | | | | |
|---|---|---|---|---|---|---|
| \| | | ├ | ″High End″ | | | |
| \| | | \| | └ | Implementation: Use only gold contacts | | |
| \| | | ├ | ″Integrated″ | | | |
| \| | | \| | └ | Implementation: | | |
| \| | | \| | | ├ | Basic control of DVD player possible by TV remote | |
| | | | | | control | |
| \| | | \| | | └ | Basic control of TV possible by DVD remote control | |
| \| | | └ | ″Innovative″ | | | |
| \| | | | └ | Implementation: | | |
| \| | | | | ├ | Offer of free content | |
| \| | | | | └ | Adjust RC standard across all products | |
| ├ | Portfolio element: TV | | | | | |
| \| | └ | Value: Best TV experience at highest technical standard | | | | |
| \| | | ├ | Portfolio element: TV set | | | |
| \| | | \| | └ | Quality: | | |
| \| | | \| | | ├ | ″Cinemalike″ (Standalone value) | |
| \| | | \| | | \| | └ | Implementation: Setting options for widescreen format |
| \| | | \| | | ├ | ″Innovative″ (Standalone value) | |
| \| | | \| | | \| | └ | Implementation: 3D visualization with polarization |
| | | | | | | filter glasses |
| \| | | \| | | └ | ″High end″ (Family value) | |
| \| | | \| | | | └ | Implementation: Use only gold contacts |
| \| | | └ | Portfolio element: TV RC (Remote Control) | | | |
| \| | | | └ | Quality: | | |
| \| | | | | ├ | ″Cinemalike″ (Standalone value) | |
| \| | | | | \| | └ | Implementation: Setting options for widescreen format |
| | | | | | | by RC |
| \| | | | | └ | ″Integrated″ (Family value) | |
| \| | | | | | └ | Implementation: Basic control for DVD player |

| ├ | Portfolio element: Internet offering | |
|---|---|---|
| ├ | Portfolio element: RC Standard (Remote Control Standard) | |
| └ | Portfolio element: DVD | |
| | └ | Value: Reliable reproduction of the disk content |

| ├ | Portfolio element: DVD player | | | |
|---|---|---|---|---|
| \| | └ | Quality: | | |
| \| | | ├ | Reliability (Standalone value) | |
| \| | | \| | └ | Implementation: Error handling for damaged locations |
| \| | | ├ | ″Innovative″ (Standalone value) | |
| \| | | \| | └ | Implementation: Internet streaming function |
| \| | | └ | ″High end″ (Family value) | |
| \| | | | └ | Implementation: Use only gold contacts |

| | |
|---|---|
| └ | Portfolio element: DVD RC |

| | |
|---|---|
| └ | Quality: |

| ├ | ″Integrated″ (Family value) | |
|---|---|---|
| \| | └ | Implementation: Basic control for TV |

| | |
|---|---|
| └ | ″Innovative″ (Standalone value) |

| | |
|---|---|
| └ | Implementation: Key functions |

The definition of a new SW system can therefore in the present case take place without a product manager or system architect. An erroneous description or incorrect evaluation of interdependencies and dependencies of the individual components among one another because of a lack of specialist expertise for the subdomain in question can thus be ruled out. This also applies when a comprehensive definition of system requirements is made. This also makes the management of projects for complex systems less complex, less error-prone, more plannable and generally more manageable. This relates to almost all disciplines, such as for example development, maintenance and marketing. Typical features that are considered in the management of such projects are for example value, effort, duration, costs, delivery time or personnel requirements.

The procedures described herein provide consequential changes, so that a well-founded cost/benefit analysis can always be carried out. They may, therefore, overcome previous disadvantages of central sequential management, in which changes are unplanned and dealing with the changes results in extra costs, delays and often also in conflicts among the project participants, using conventional management models. This enables a new, more efficient way of collaboration between project partners within a company but also partners from different companies, as a more solid knowledge base can be accessed for decision making, since knowledge from the problem space and solution space is considered and used jointly instead of being separated. Individual management tasks can be reliably analyzed and considered “separately” but also “jointly” on the basis of a common database. Different scenarios can be run through easily and with little effort. Instead of having to rely on a few “experts for everything” who laboriously think everything through and define it in advance, the knowledge of many individual experts is used to make system decisions. And instead of having to spend a lot of money on system descriptions, it is ensured that as much of the available budget as possible is available for the actual project work.

### LIST OF REFERENCE CHARACTERS

10 System visualization
20 Method visualization
11 Product idea, idea
12 Market analysis, market survey, in particular in respect of relevance, priority and fulfillment
13 CVE benchmark
21 Overarching features of the idea
22 Customer-specific features, customer values
31 Why?
32 How?
33 What?
23 Project plan
SD Hierarchical system description
CS Atomic base structure
C Self-similar components, such as for example quality, value assignment, feature assignment
val Features, characteristic values, a feature is for example defined via a link to predefined feature definitions (pre), is for example a component-specific value which can be specified manually or can be determined by aggregation, the aggregation rule to be applied is in particular defined for a component (C), a component (C) in particular also comprises a definition of interdependencies (Q) between the lower-level children, the subcomponents (sub)
sub subcomponents, such as for example design, budget, performance, execution, plausibility, consistency, HW and SW balancing, guidelines, dependencies, planning data and the prioritization thereof, based on speed, scheduling, participants, skills, risks, etc.
I Receipt
PI Project-relevant information, data, for example development tool GIT, freely available open-source system for the distributed versioning of software parts
AM Recursive algorithm, or recursive feature computer AM
O Automated output, for example of system description data
data System description data, in particular in preset formats in accordance with specified rules, for example project management tool MS Project, Polarion, TFS (Team Foundation Server is an application Lifecycle Management (ALM) platform from Microsoft), backlog, a dynamic list of work assignments/requirements to be carried out, VS cards, TC (Teamcenter: Product Lifecycle Management system (PLM system) from Siemens), SAP (software for the control of business processes), TcPCM (software for the control of business processes)
Q Interdependencies
pre Memory of predefined feature definitions, aggregation rules and interdependency types (Q)
map Mapping rules for continuous input and output
CS Atomic component structure
PD Product description
QE Interdependency editor
SE System description editor
OE Organization editor
ME Feature editor
I/O Input/output component

What is claimed is:

1. A method for system description, the method comprising:
forming a standardized atomic base structure for description of individual components of a system, so all components are self-similar,
wherein the description includes a predefined set of features, aggregation rules, and interdependencies;
editing the system description, by firstly dividing up hierarchically into individual components and subcomponents as far as an atomic base structure, and describing the individual components and subcomponents, wherein the descriptions of the individual components and subcomponents then form the hierarchical system description by definition and combination;
receiving project-relevant information from other software modules for sorting into the appropriate locations in the system description, wherein for processing a semantic description is given of how, when, and which data is to be taken over from which software module or data repository;
analyzing the components using a recursive algorithm and deriving the characteristic values required for the system description;
wherein the definition of aggregation rules for individual components and subcomponents takes place such that the aggregation rules describe how the features can be aggregated across subcomponents;
calculating across all components subcomponents of the system description and generating analysis results for the knowledge level of the system to be described; and
transmitting output of system description data in preset formats in accordance with specified rules.

2. The method as claimed in claim 1, further comprising generating a standardized definition of interdependencies to other subcomponents.

3. The method as claimed in claim 1, wherein each of the individual component descriptions is self-contained and can be considered independently.

4. The method as claimed in claim 1, wherein dependencies to other components are defined at the respectively higher-level component level and are mirrored into the lower-level components.

5. The method as claimed in claim 1, wherein the recursive algorithm follows a recursion rule that all paths are run through.

6. The method as claimed in claim 1, wherein the recursive algorithm follows a recursion rule that the aggregation of the numerical values or other aggregatable individual features takes place in the components run through.

7. The method as claimed in claim 1, wherein the recursive algorithm follows a recursion rule that dependencies are defined by formation of references between tasks inside a component.

8. The method as claimed in claim 1, wherein the recursive algorithm follows a recursion rule that individual features are only actively taken into account in connection with specified data constellations or for a specified calculation.

9. The method as claimed in claim 8, wherein a specified calculation is a specified task which arises only under specified conditions.

10. A computer system comprising:
a memory module storing a system description;
a software module to edit the system description, wherein the system is firstly divided up hierarchically into individual components and subcomponents as far as an atomic base structure, and the individual components and subcomponents are described, wherein the descriptions of the individual components and subcomponents then form the hierarchical system description by definition and combination;
a second software module with a functionality for importing, copying, and organizing system description components;
a receipt module to receive project-relevant information from other software modules and for sorting into the appropriate locations in the system description, wherein for the automated processing a semantic description is given of how, when and which data is automatically to be taken over from which software module or data repository;
an analysis module to perform calculations across all components and subcomponents of the system description and generates analysis results for the knowledge level of the system to be described; and
an output module to transmit system description data in preset formats in accordance with specified rules.

11. The computer system as claimed in claim 10, having a third software module for editing and defining cross-system features.

12. The computer system as claimed in claim 10, having a fourth software module for editing a description of interdependencies between individual subcomponents, in particular on the basis of a predefined semantic vocabulary.

13. The computer system as claimed in claim 10, having an output module to forward the system description data to other systems in accordance with specified rules.
